(19) United States
(12) Patent Application Publication
(10) Pub. No.: US 2015/0006353 A1
(43) Pub. Date: Jan. 1, 2015

(54) PROVIDING A LIQUIDITY BASED METRIC AND INDEX FOR LOW LIQUIDITY SECURITIES

(71) Applicant: BLOOMBERG FINANCE L.P., New York, NY (US)

(72) Inventors: William Gartland, Fairfield, CT (US); Peter Cotton, New York, NY (US); Nicholas Jordan West, New York, NY (US)

(21) Appl. No.: 14/296,833

(22) Filed: Jun. 5, 2014

Related U.S. Application Data
(60) Provisional application No. 61/839,646, filed on Jun. 26, 2013.

(51) Int. Cl. G06Q 40/04

(52) U.S. Cl. CPC G06Q 40/04
USPC 705/37

(57) ABSTRACT

Methods, systems, and apparatus, including computer program products, for providing a liquidity based metric and/or index for low liquidity securities. In an aspect, actions can include receiving transaction data including data relating to one or more transactions of a first security, obtaining, using a data processing apparatus, one or more reference values, in which each reference value is contemporaneous with a corresponding transaction of the first security, generating, using the data processing apparatus, a transaction liquidity factor for each reference value-transaction pair, and combining the transaction liquidity factors into an asset liquidity factor for the first security.

### RELATED APPLICATIONS

This application discloses the same subject matter as U.S. Provisional Application No. 61/645,981, filed May 11, 2012 and U.S. Provisional Application No. 61/839,646, filed Jun. 6, 2013, the priorities of which are claimed for this application. The disclosures of Application Nos. 61/839,646 and 61/645,981 are incorporated herein by reference.

### BACKGROUND

Liquidity can be understood as being representative of how easily an investor can conduct a transaction (e.g., a purchase or sale) with respect to a financial instrument without substantially affecting the asset's price. Thus, in some instances, liquidity is a measure of the market's expectation of volatility. Measures of liquidity are more easily derivable in equity markets (e.g., stock market or other exchange traded stocks) where more volume is exchanged and the market contains more inherent liquidity. In contrast, in an illiquid market, sellers cannot easily find buyers, and sellers cannot get their money out of their investments with any certainty. A relatively liquid market tends to have better price stability and increased order volume than a relatively illiquid market because issuers, investors, and market participants seek the most liquid market places.

Liquidity measures can often be generated for exchange traded markets, where trading is transparent and liquidity is higher. However, exposing liquidity is generally difficult in marketplaces that are not exchange traded, such as certain fixed income markets and markets for trading over-the-counter (OTC) derivatives. Traditional measures of liquidity in the fixed income markets capture the level of trading activity in an asset, but do not measure the quality and consistency of a transaction prices. Furthermore, measurements of liquidity in fixed income and OTC derivative markets can be overly reliant on sparse underlying data points and inaccurate end of day prices. For example, in some cases, liquidity in the market is measured by comparing market-wide average price quotes to reported transactions, and assessing the deviation of reported transactions from the average end of day prices, in which the deviation for each transaction reflects the relative liquidity of the underlying security.

In another example, prices associated with security transactions across time are compared, and a portion of the “price bounce” of the security between trades is attributed to a measure of the security's illiquidity. The illiquidity measure relies on records of completed transactions and is therefore limited by the accuracy of the previous trades as well as the inherent accuracy of the “price bounce” itself. Among other problems, it is difficult to account for various idiosyncrasies across assets with any accuracy or to normalize the results. Additionally, any given transaction made at a non-optimal price can radically transform the metric both as the metric relates to the given transaction and any future transaction in which that non-optimal price is the reference.

### SUMMARY

The subject matter of this disclosure relates to providing liquidity based metrics for low liquidity securities.

For the purposes of this disclosure, low liquidity securities are understood to include financial instruments in which it may be initially difficult for a potential investor to conduct transactions with respect to the instrument, without substantially affecting the instrument's price. Low liquidity securities may be obtained through, for example, non-exchange traded markets and can include fixed income assets, such as bonds, or OTC derivatives, such as credit-default swaps. Other types of financial instruments, such as thinly traded stocks (including may small cap stocks), out of money options on stocks, futures, and foreign exchanges, some of which are exchange traded and some of which are over the counter, also may be considered low liquidity securities.

For the purposes of this disclosure, a liquidity metric is understood to mean a metric that represents a level of certainty around an execution price, where the execution price is the price the security in a transaction.

For the purposes of this disclosure, a liquidity index is understood to mean an index representative of the liquidity of an underlying portfolio of financial instruments. The portfolio can, but does not necessarily, represent a particular market or portion of a market.

An innovative aspect of the subject matter described in this specification can be embodied in computer-based methods that include the actions of receiving transaction data including data relating to one or more transactions of a first security, obtaining, using a data processing apparatus, one or more reference values, in which each reference value is contemporaneous with a corresponding transaction of the first security, generating, using the data processing apparatus, a transaction liquidity factor for each reference value-transaction pair, and combining the transaction liquidity factors into an asset liquidity factor for the first security.

Other embodiments of this aspect include corresponding computer systems, apparatus, and computer program products encoded on computer-readable media, each operable to cause a data processing apparatus to perform the actions of the methods. A system of one or more computers can be configured to perform particular operations or actions by virtue of having software, firmware, hardware, or a combination of them installed on the system that in operation causes the system to perform the actions. One or more computer program products can be configured to perform particular operations or actions by virtue of including instructions that, when executed by data processing apparatus, cause the apparatus to perform the actions.

The foregoing and other embodiments can each optionally include one or more of the following features, alone or in combination. For example, the transaction data can include transaction data selected from the group consisting of transaction data relating to trades in fixed income assets reported by members of FINRA under TRACE and information provided to a centralized recordkeeping facility.

In some implementations, the transaction data comprises data related to a single security. In some implementations, the methods further include receiving market data, in which each reference value is based at least in part on the market data, and the market data includes data selected from the group consisting of: data related to interest rate swaps, data related to volatility of options to swap; data related to trades in fixed income assets; data related to information obtained from a swap data repository, data related to treasury prices, data related to credit default swaps, and combinations thereof. In some cases, the methods can further include filtering the market data to obtain the transaction data.

In certain implementations, generating the transaction liquidity factor includes calculating the transaction liquidity factor according to the formula: v(t−p)², in which v is volume of a transaction involving the first security, t is the trade value for the transaction involving the first security, and p is the reference value for the transaction involving the first security.

Combining the transaction liquidity factors can include, for example, calculating a raw liquidity factor according to the formula:

$$\frac{\sum {{v}_{i} ( {t}_{i} - {p}_{i} )}^{2}}{\sum {v}_{i}} ,$$

for i=1 . . . n, in which n is the total number of transactions involving the security, vᵢ is volume of the ith transaction involving the first security, tᵢ is the trade value of the ith transaction involving the first security, and pᵢ is the reference value for the ith transaction involving the first security.

The method can further include outputting, to a display, a graphical relationship between a portion of the transaction data and the one or more reference values. The graphical relationship can include a histogram plot, in which the histogram plot includes a representation of transaction data and dispersion values. The dispersion values can include measures of dispersion between transaction values and contemporaneous reference values.

In some implementations, the methods can further include selecting one or more additional securities, obtaining an asset liquidity factor for each additional security underlying the index, and generating a liquidity index based on a combination of the asset liquidity factor for each additional security and the asset liquidity factor of the first security. Selecting the one or more additional securities can be based on, for example, one or more asset selection criteria. The asset selection criteria can include one or more criteria selected from the group consisting of in house validation, information related to security issuance, security rating, security time to maturity, security type, and outstanding part amount. In some implementations, the combination includes a weighted averaging of the asset liquidity factor for each additional security and the asset liquidity factor of the first security.

Another innovative aspect of the subject matter described in this specification can be embodied in a system that includes a transaction data interface for receiving records of transactions related to one or more securities, a data processing apparatus coupled to the transaction data interface, in which the data processing apparatus is operable to perform operations including obtaining one or more reference values, in which at least one reference values is contemporaneous with a corresponding transaction received by the transaction data interface, generating an asset liquidity factor for each security, and outputting to a display information related to the asset liquidity factor for each security.

Other embodiments of this aspect include corresponding methods of operation, or apparatus and computer program products encoded on computer-readable media, in which each of the apparatus and computer program products is operable to cause a data processing apparatus to perform the actions of the methods of operation. One or more computer program products can be configured to perform particular operations or actions by virtue of including instructions that, when executed by data processing apparatus, cause the apparatus to perform the actions.

The foregoing and other embodiments can each optionally include one or more of the following features, alone or in combination. For example, generating the asset liquidity factor can include calculating a dispersion between each reference value and a corresponding transaction value of each security. Calculating the dispersion between each reference value and the corresponding transaction value may be based at least in part on a volume associated with the corresponding transaction. In some implementations, the reference value represents a price of the security or a yield of the security that is contemporaneous with the transaction value.

The records of transactions can include, for example, data relating to one or more parties participating in at least one of the transactions. In some implementations, outputting to the display information related to the asset liquidity factor includes outputting information related to a type of party participating in at least one of the transactions. In some cases, the records of transactions include data relating to one or more selected from the group consisting of: a quantity of transactions, a quantity of securities, and an exchange value.

Another innovative aspect of the subject matter described in this specification can be embodied in a system that includes a market data interface for receiving market data relating to the transactions of a plurality of securities, and a data processing apparatus coupled to the market data interface, the data processing apparatus being operable to perform operations that include filtering the market data to obtain transaction data related to transactions of one or more specified securities, obtaining one or more reference values, in which at least one of the reference values is contemporaneous with a corresponding transaction of the transaction data, and outputting, to a display, a graphical relationship between a portion of the transaction data and the one or more reference values.

Other embodiments of this aspect include corresponding methods of operation, or apparatus and computer program products encoded on computer-readable media, in which each of the apparatus and computer program products is operable to cause a data processing apparatus to perform the actions of the methods of operation. One or more computer program products can be configured to perform particular operations or actions by virtue of including instructions that, when executed by data processing apparatus, cause the apparatus to perform the actions.

The foregoing and other embodiments can each optionally include one or more of the following features, alone or in combination. For example, the graphical relationship can include a histogram plot, in which the histogram plot includes a representation of transaction data and dispersion values. The dispersion values can include measures of dispersion between transaction values and contemporaneous reference values. In some implementations, an origin of the histogram plot represents a reference value contemporaneous with a transaction value of a corresponding transaction. Each contemporaneous reference value may correspond to a reference price or a reference yield.

In some implementations, the transaction data includes data relating to information about one or more parties participating in a transaction. The graphical relationship can include a histogram plot, and at least one visual feature of at least a portion of the plot relates to the information about the one or more parties participating in the transaction.

In some implementations, the transaction data includes at least one data point selected from the group consisting of: quantity of transactions, quantity of securities transacted, amount of value exchanged, and combinations thereof. In some cases, the histogram plot includes a display of a plurality of transaction buckets, each bucket representing a range of transaction values in relation to a corresponding contemporaneous reference value. The range of transaction values can be in units of one half of a spread between a reference bid price and a reference ask price.

Particular embodiments of the subject matter described in this specification can be implemented so as to realize one or more of the following advantages. For example, in some implementations, a measure of liquidity is provided for fixed income and OTC derivative markets, in which the liquidity measure provides high accuracy despite sparse available data. The liquidity metric can be used to generate a measure of price certainty in an otherwise illiquid marketplace. The liquidity measures can be obtained without being solely dependent on end of day security transaction pricing. Other advantages include, for example, the ability to provide liquidity information on both an individual security level and a market level. Implementations can include providing a liquidity index based on a liquidity metric, as well as providing a set of tools that allow third parties to create their own liquidity index.

In some implementations, the system for generating the liquidity metric offers coherent and transparent displays of the liquidity metric along with or independent of displays of empirical data in the context of the calculated metric. Among other advantages, tools are provided that can be used by end users in order to leverage the liquidity metrics. For example, in some implementations, regression analysis tools can be used to infer information about segments of the marketplace for which little data exists. Another advantage includes providing a user with one or more portfolio management tools that allow the user to measure and optimize liquidity in a portfolio as well as assess the user's own liquidity tolerance. This can include transaction level analysis as well as projected and actual market impact from trades.

For the purposes of this disclosure, low liquidity securities are understood to include financial instruments in which it may be initially difficult for a potential investor to conduct transactions with respect to the instrument, without substantially affecting the instrument's price. Low liquidity securities may be obtained through, for example, non-exchange traded markets and can include fixed income assets, such as bonds, or OTC derivatives, such as credit-default swaps. Other types of financial instruments, such as thinly traded stocks (including small cap stocks), out of money options on stocks, futures, and foreign exchanges, some of which are exchange traded and some of which are over the counter, also may be considered low liquidity securities.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a flow chart depicting an example process for providing a liquidity metric for a specified low liquidity security;

FIG. 2 is a flow chart depicting an example process for providing a liquidity index for a set of low liquidity securities;

FIG. 3 is a flow chart depicting an example process for generating, on a display, transaction information related to one or more securities in order to provide a graphical representation of liquidity;

FIG. 4 is a graphical representation of transaction data for low liquidity securities;

FIG. 5 is a schematic representation of an exemplary system that includes an implementation of the invention; and

FIG. 6 is a plot of an example liquidity index calculated for multiple underlying securities over time.

### DETAILED DESCRIPTION

The present disclosure relates to, among other things, techniques for providing liquidity metrics for low liquidity securities such as, for example, fixed income assets and OTC derivatives. The techniques cover, as an example, compiling a list of transactions for a particular low liquidity security, generating a reference value for the low liquidity security, in which the reference value is contemporaneous with a corresponding transaction value associated with the security, calculating a dispersion between the reference value and the corresponding transaction value, calculating a liquidity metric based on the dispersion, and outputting the results to a display. The reference value can be in terms of a price or yield for a security, and can either reflect the contemporaneous value of the security at the time of the transaction or a prediction of the value of the next transaction of that security contemporaneous with the time of the transaction.

The present disclosure also relates to providing a liquidity index. Providing an index for low liquidity securities can include, for example, selecting a set of low liquidity securities, compiling a list of transactions for the selected low liquidity securities, generating a reference value for each security, in which the reference values are contemporaneous with corresponding transaction values associated with each security, calculating the dispersion between the reference values and the corresponding transaction values, calculating a liquidity metric for each security based on the dispersion, and combining the liquidity metrics for each security to provide a liquidity index. For example, a weighting can be applied to the liquidity metric associated with each security, in which the weighting is based on factors such as the total market value of a security issue, the total market value of a given transaction, or the total number of assets transacted. Alternative weightings also can be applied.

In some implementations, liquidity indices are provided that are associated with, for example, investable components, daily (or more frequent) performance data, timely index characteristics (pricing, composition, etc.), historical information, a makeup that reflects current market dynamics, low turnover, transparency, a threshold that is specified in advance, or other characteristics. An index may be used to measure changes in an economy, portfolio, sector or other aspect of a market. An index can have a calculation methodology.

The present disclosure also relates to displaying transaction information related to one or more securities in order to provide a graphical representation of liquidity. For example, displaying transaction information can include sorting transactions into histogram buckets, where each bucket represents transactions that occurred some distance from a reference value associated with the corresponding transactions. Displaying the measure of liquidity also can include generating reference bid/ask spread associated with the reference values and generating histogram buckets based on normalized units of the bid/ask spread. Other ways of displaying a measure of liquidity also can be used, such as displaying the transaction data in other relevant groupings or in historical windows.

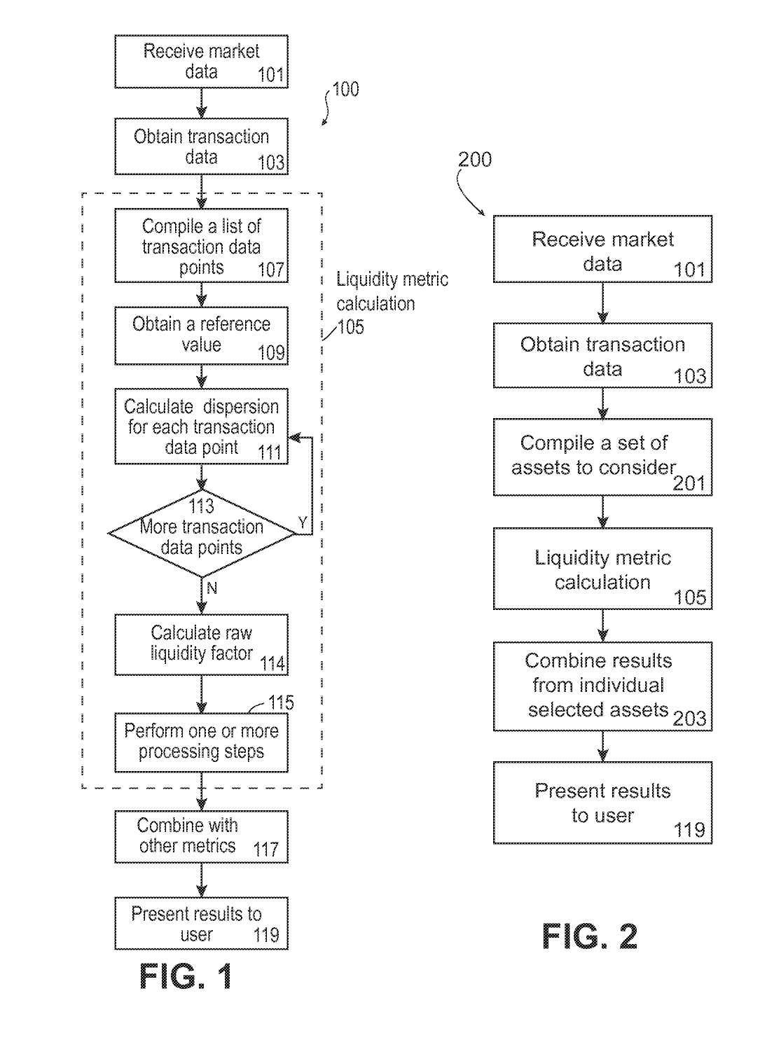

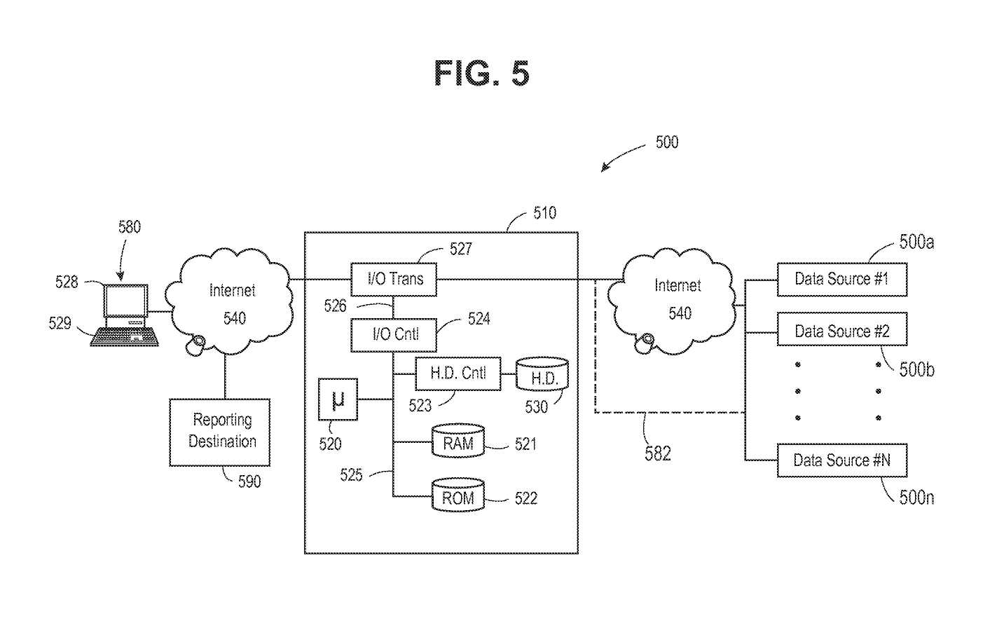

FIG. 1 is a flow chart depicting an example process 100 for providing a liquidity metric for a given low liquidity security. The process 100 can be implemented in a data processing apparatus of one or more computers and memory storage systems such as the system 500 described below and shown in FIG. 5. For example, referring again to FIG. 1, in some implementations, a data processing apparatus receives (101) market data for a group of different low liquidity securities (e.g., fixed income assets and OTC derivatives). The market data can include, for example, transaction data about trades in fixed income securities reported by members of the Financial Industry Regulatory Authority (FINRA) under the Trade Reporting And Compliance Engine (TRACE) program. Other market data can include, for example, transaction data obtained from centralized recordkeeping facilities, such as Swap Data Repositories (SDR) or the municipal securities rulemaking board (MSRB) Real-time Transaction Reporting System (RTRS). Transaction data can include a transaction price or yield associated with one or more transactions of a security, a transaction volume associated with one or more securities, identification of the issuer of the security, and/or transaction dates/times, among other information. Market data from other applicable reporting authorities also can be used. Alternatively, or in addition, the market data can include information related to United States Treasury Securities such as, for example, one or more quotes for proposed transactions (e.g., sales or purchases of securities), as well as one or more quotes for transactions of other comparable securities, such as securities issued by the same party or securities issued in the same industry sector. The data processing apparatus can receive the market data in data feeds over a network or the market data may be electronically acquired by the data processing apparatus, in which the data processing apparatus submits a request for the data over a network and electronically receives the data in response. The data processing apparatus then can store the market data in a database associated with the system.

The data processing apparatus then obtains (103) transaction data for a particular low liquidity security (e.g., fixed income security or OTC derivative). The particular security of interest can be specified by user input or the system can be configured to identify certain types of securities for which a liquidity analysis is to be performed. Alternatively, the system can be configured to automatically identify any securities within the market data and perform a separate liquidity analysis for each identified security.

In obtaining the transaction data for a particular low liquidity security, the data processing apparatus can filter the market data that has been received in procedure (101) of process 100 to isolate transaction data associated with a specified low liquidity security. Accordingly, transaction data can include, for example, a subset of the market data already received. Alternatively, or in addition, the transaction data relevant to a specified low liquidity security can be acquired independently or may be entered manually into the data processing apparatus.

After obtaining transaction data for a specified type of low liquidity security, the data processing apparatus calculates (105) a liquidity factor, using a dispersion methodology based on a dispersion of one or more transactions for the specified low liquidity security around a reference value (e.g., a reference price or yield point) determined from the market data and/or the transaction data. In general, the liquidity metric calculation (105) includes compiling (107) a list of relevant transaction data points. Relevant transaction data points include, for example, data points within the transaction data that represent transactions involving the asset being assessed. In some implementations, the transaction data points include, for example, information about completed trades of the specified security, such as price of the trade and time at which the trade occurred. The relevant transaction data points can also include information about proposed transactions including, for example, a proposed trade price and/or trade time. The list of relevant transaction data points can include the same transaction data points obtained in procedure (103) or, alternatively, some subset of the transaction data points obtained in procedure (103). For example, in some implementations, a user can specify that the data processing apparatus include only transaction data points for a particular low liquidity security occurring within a price range or within a fixed time period.

After the list of transaction data points for a particular type of low liquidity security has been compiled, a reference value is obtained (109) for each transaction data point in the list, in which the reference value is contemporaneous with the corresponding transaction data point. That is to say, the reference value represents a projected transaction value for the low liquidity security for the same point in time as the corresponding transaction data point in the list. Thus, the reference value may be, in part, time-dependent. Additionally, in this way, each transaction data point is paired with a reference value. Variations in reference value can be based on parameters such as changes in transaction values associated with other securities in the market data, trade volume of other securities in the market data, and/or transaction timing (e.g., how often a security is exchanged) of other securities in the market data.

A reference value can correspond to, for example, a reference price or a reference yield for the particular type of security being evaluated. Each reference value is calculated using information obtained from the received market data. In particular, the reference values may be, for example, calculated based on prices and/or yields of low liquidity securities that are comparable or similar to the security being evaluated. However, the reference value is independent of the specified transaction data point. For example, if the low liquidity security being analyzed is a corporate bond issued from a company in the semiconductor industry, then a reference value for a transaction associated with that bond can be calculated based on prices and/or yields of bonds (or other low liquidity securities) issued by other entities in the semiconductor industry as well as prices and/or yields of other transactions in that bond.

For each pairing of a transaction data point and a reference value, the dispersion of the relevant exchange data point is calculated (111). For example, the dispersion can be expressed using the formula vᵢ(tᵢ−pᵢ)², where vᵢ is volume associated with the ith transaction of the specified low liquidity security, tᵢ is the trade value associated with the ith transaction of the specified low liquidity security, and pᵢ is the reference value associated with the ith transaction of the specified low liquidity security. This procedure can be repeated (113) until a dispersion value has been calculated for each relevant transaction data point. In some implementations, the dispersion values are calculated over a specified window of time and stored in memory. This time period can include, for example, several minutes, hours, days, weeks or more. In some implementations, a user specifies the length of the window for collecting dispersion values, though the length of the window can be programmed beforehand or, alternatively, the data processing apparatus can be configured to automatically select an appropriate time window. For example, the data processing apparatus can be configured to automatically select an appropriate time window based on how many transaction data points have been obtained for the specified low liquidity security or based on an average frequency of transactions over a set time period, among other parameters.

A raw liquidity metric can then be calculated (114) for the specified low liquidity security. In some implementations, the raw liquidity metric corresponds to a value representative of the ease with which an investor can conduct a transaction with respect to the particular security being analyzed. For example, a security having a relatively low raw liquidity metric is less liquid than a security having a relatively high raw liquidity metric. Thus, it may be more difficult for an investor to obtain a buyer for the security having a lower raw liquidity metric. The raw liquidity metric can be expressed as, for example,

$$\frac{\sum {{v}_{i} ( {t}_{i} - {p}_{i} )}^{2}}{\sum {v}_{i}} ,$$

where the parameters vᵢ, tᵢ, and pᵢ have been defined above. Other different formulas can be used to calculate either the dispersion values or the raw liquidity metrics.

One or more further processing steps then can be performed (115) such as scaling the raw liquidity factor. For example, in some implementations, the raw liquidity metric can be scaled in accordance with a reference bid/ask spread. Similar to the reference value described above, a reference bid can represent a projected bid (e.g., buyer offer) price for a low liquidity security that is contemporaneous with the corresponding transaction data point, and a reference ask (e.g., seller offer) can present a projected ask price for a low liquidity security that is contemporaneous with the corresponding transaction data point. The reference bid/ask spread then corresponds to the difference between the reference bid and the reference ask. Scaling the liquidity metric can place the raw liquidity metric in a more appropriate context for evaluating the relative liquidity of different securities. In some implementations, scaling the liquidity metric can include normalizing the liquidity metric to provide a unitless measurement of liquidity.

In some implementations, the raw liquidity metric can be scaled over a series of time periods within which principal payments of the low liquidity security are to be paid (e.g., “maturity buckets”). Other parameters can be used to scale the liquidity metric as well. For example, the raw liquidity metric of a particular low liquidity security being analyzed may be scaled by a factor based on characteristics of the security, such as rating or time to maturity.

The scaled liquidity metrics then can be optionally combined (117) with other relevant metrics such as, for example, the number of days there has been no trade for the security (O-trade days) in a time period, total volume traded, average trade size, and trade count. Combining the liquidity metrics with other relevant metrics can include modifying the liquidity metric to create a liquidity score that can be easily quoted and understood. The results then are output (119) for display. For example, the liquidity metrics for multiple securities may be displayed in a plot versus the total volume traded for each security, the average size of the trade for each security having a liquidity value, or the number of O-trade days, among other parameters. In some implementations, the liquidity metric is presented in a time-series plot showing the change in liquidity over time for a particular security.

In some implementations, the system returns the raw or normalized results of the methodology without further adjustment to the data. In some implementations, the reference values and/or transaction data are presented in a plot as objects (e.g., square, circle, triangle, etc.). The objects can be displayed as part of a time series or as a function of another parameter (type of security, issuer, volume, etc.). A characteristic of each object may vary in the plot depending on one or more parameters (e.g., the liquidity metric associated with the corresponding reference value and/or transaction data, trading volume of the underlying security, number of 0-trade days). For example, the color and/or size of the object may vary depending on the one or more parameters.

FIG. 2 is a flow chart depicting an example process 200 for providing a liquidity index for low liquidity fixed income assets and markets. The process 200 can be implemented in a data processing apparatus of one or more computers and memory storage systems such as the system 500 described below and shown in FIG. 5. For example, referring again to FIG. 2, a data processing apparatus of the system receives (101) market data for low liquidity securities. The market data can include, for example, information about trades in fixed income securities reported by members of FINRA under the TRACE program. Other market data can include, for example, information obtained from centralized recordkeeping facilities, such as SDRs and the MSRB RTRS. Market data from other applicable reporting authorities also can be used. Alternatively, or in addition, the market data can include information related to United States Treasury Securities such as, for example, one or more quotes for proposed transactions (e.g., sales or purchases of securities). The market data also can include information such as volume of transactions for each different type of low liquidity security. The data processing apparatus can receive the market data in data feeds over a network. Alternatively, or in addition, the data processing apparatus acquires the market data by submitting electronic requests over the network to the data repositories and receiving the market data in response to the request. The data processing apparatus then can place the market data in a database associated with the system.

The data processing apparatus then obtains (103) transaction data for multiple low liquidity securities (e.g., fixed income securities or OTC derivatives). The securities selected can be specified by user input or the system can be configured to identify certain types of securities for which liquidity analysis is to be performed. Alternatively, the system can be configured to automatically identify any securities within the market data and perform a separate liquidity analysis for each identified security.

In obtaining the transaction data for a particular low liquidity security, the data processing apparatus can filter the market data that has been received in procedure (101) of process 100 to isolate transaction data associated with specified low liquidity securities. Accordingly, transaction data can include, for example, a subset of the market data already received. Alternatively, or in addition, the transaction data relevant to specified low liquidity securities may be entered manually into the data processing apparatus.

The data processing apparatus then compiles (201) a set of low liquidity securities from the market data for further analysis. For example, in some implementations, the data processing apparatus selects a subset of fixed income assets from the market data for the index. This selection process can be based on several different criteria including, for example, whether the security has been validated, issuance information associated with the security, asset type, rating, time to maturity, outstanding par amount, among others. In the alternative, users can apply the methodology to their own list of securities or their own portfolio. Validation can refer to whether a particular security has been priced by a pricing service or some other validation metric. Issuance information associated with a security corresponds to details associated with the issuance of a security such as, for example, the scale of an issuance associated with a security or the markets in which the issuance of the security has taken place. The asset type refers to the category of asset such as, for example, bullet bonds in the case of fixed income securities. The rating of a security can be determined by either an outside rating firm or by using the data processing apparatus. In some implementations, a user can manually enter, through a user interface, the particular securities for which a liquidity index should be determined. Alternatively, the data processing apparatus can output to a display a list of securities to process, from which a user can select the desired securities.

Once a list containing the specified low liquidity securities are obtained, the data processing apparatus applies (105) the dispersion methodology, as explained above with respect to FIG. 1, to each individual security within the list. Accordingly, a liquidity metric is obtained for each security. A liquidity index is then determined (203) based on the individual liquidity metrics associated with each security. The liquidity index provides a measure of liquidity for the underlying securities as a whole.

In some implementations, the raw liquidity metrics obtained by applying the dispersion methodology to each security are combined to yield the liquidity index. The combination can be based on an averaging of the liquidity scores for the individual securities. The averaging may be an equal-weighted average of the liquidity metrics. Alternatively, the averaging may be weighted based on one or more factors. For example, the weighting can include a volume weighting of the individual liquidity measures such that greater influence is given to securities issued in larger quantities or transacted in larger quantities. In another example, the individual liquidity metric for each security can be weighted by market value of a security issuance such that greater influence is given to securities that issue with larger overall values or securities for which greater value has been exchanged. Factors other than volume and market value also may be used to weight the liquidity metric associated with each security in addition to or in place of the foregoing examples. In some implementations, the data processing apparatus then outputs (119) information relating to the liquidity index to a display.

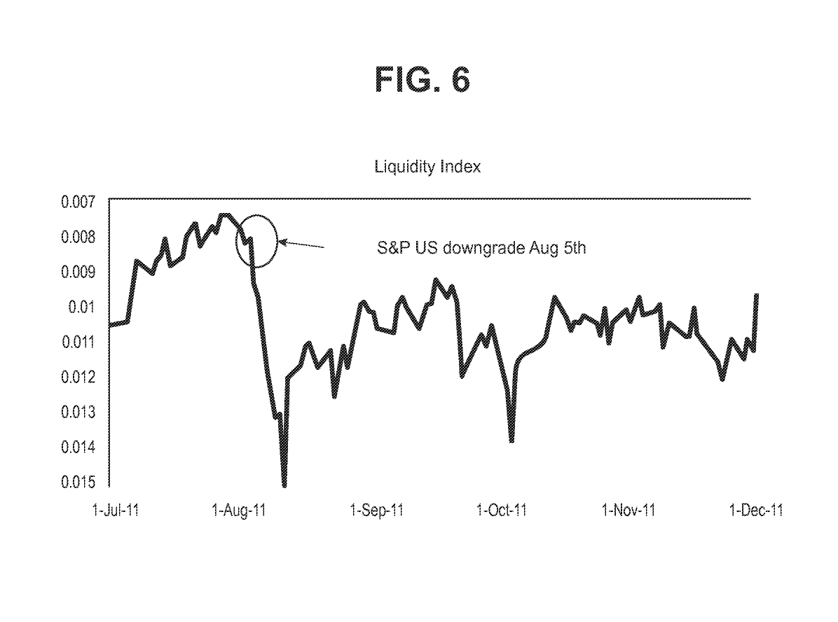

For example, FIG. 6 is a plot of an example liquidity index (vertical axis) calculated for multiple underlying securities over time (horizontal axis). In the example shown in FIG. 6, a larger numerical value indicates less liquidity. However, a liquidity index also can be calculated in which larger numerical values indicate more liquidity, simply by inverting the value of the liquidity being used.

In some implementations, information relating to a single liquidity index is output for display. In other implementations, information relating to multiple liquidity indices are output to a display by the data processing apparatus. For example, in some implementations, multiple liquidity indices can be obtained, in which a different set of securities underlies each index. Each liquidity index can be calculated using the dispersion methodology described above. In some implementations, a user interacting with the system can specify a set of liquidity indices to display.

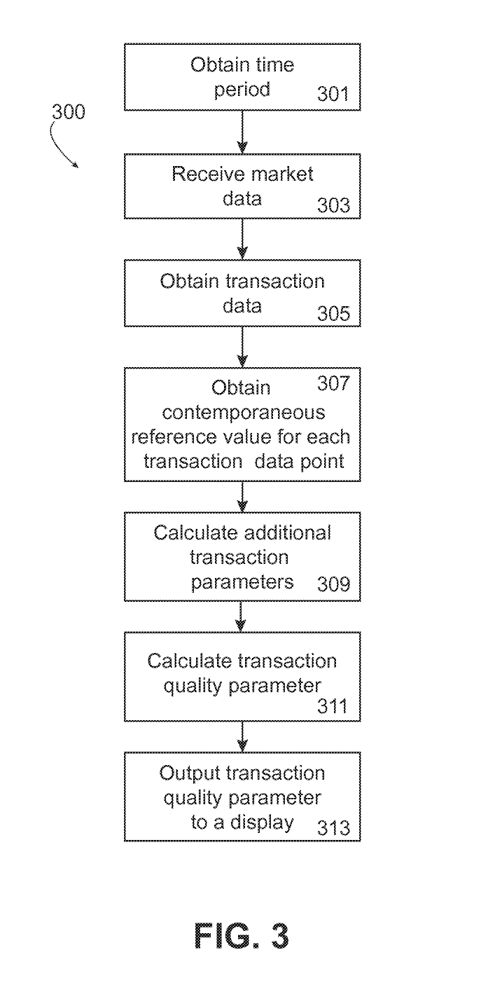

FIG. 3 is a flow chart depicting an example process 300 for presenting, on a display, transaction information related to one or more securities in order to provide a graphical representation of liquidity. The process 300 can be implemented, for example, in a data processing apparatus of one or more computers and memory storage systems such as the system 500 described below and shown in FIG. 5. The system receives (301) a selected time period. In some implementations, the user can optionally select a time period or, alternatively, a default time period can be programmed. Example time periods are 30 days or 1 month, 1 day, 2 days, 1 week, and 3 months, among others.

The system also receives (303) market data and obtains (305) transaction data. As explained above with respect to FIGS. 1 and 2, the data processing apparatus can receive market data in data feeds over a network and/or in response to an electronic request submitted by the data processing apparatus to a repository of market data. The received market data can then be stored in a database. As explained above with respect to FIGS. 1 and 2, the transaction data can be obtained from the market data and/or manually entered into the system. Both the market data and transaction data are limited to data corresponding to transactions that occur during the selected time period. Again, market data can include, for example, information about trades in fixed income securities reported under the TRACE program, information regarding security transactions obtained from centralized recordkeeping facilities, such as SDRs and the MSRB RTRS, or other reporting authorities. For each transaction represented in the selected time period, the transaction data can include, for example, the time of execution of a security transaction, the time the security transaction was reported, the trade price or yield associated with the security transaction, and/or the trade size, among other parameters. In some implementations, trade sizes are estimated based on standard reported trade sizes and in some implementations the data also includes information about the reporting party side, such as whether the reporting party was on the bid side or the ask side of a transaction. In general, the standard reported trade size is included in the market data obtained by the system.

Based on the market data and/or the transaction data for the selected time period, the data processing apparatus obtains (307) a reference value for one or more transaction data points within the selected time period, in which each reference value is contemporaneous with a corresponding transaction data point. That is to say, each reference value represents a projected transaction value for the low liquidity security occurring at the same point in time as the corresponding transaction data point.

After the reference value for each transaction is obtained, the data processing apparatus calculates (309), for each transaction data point, a corresponding estimate of additional transaction parameters. For example, the additional transaction parameters can include a reference bid value, a reference mid-value, and a reference ask value, each of which is contemporaneous with a corresponding transaction data point within the selected time range. A reference mid-value corresponds to a value that is midway between the reference bid value and the reference ask value. Thus, the additional transaction parameters represent projections of the bid value, mid value and/or ask value at the same point in time as when the security transaction occurs, and thus are, in part, time-dependent parameters.

The data processing apparatus then calculates (311) a transaction quality parameter for the each transaction data point. The transaction quality parameter corresponds to a measure of the how close the reference price is to the transaction price, relative to the difference between the bid price and offer price. For example, in some implementations, the transaction quality can be expressed according to the formula

$$C = \frac{A}{( B / 2 )} ,$$

where C is the measure of transaction quality expressed, A is the difference between the transaction value and the reference value contemporaneous with the transaction generated, and B is the difference between the bid value and the offer value from the transaction data.

The data processing apparatus then outputs (313) the transaction quality parameter to a display. The data can be presented in various formats, including, for example, a time-series plot along with the transaction data. Alternatively, the data can be displayed in a histogram plot that shows the quality parameter for different transactions of a given low liquidity security. Other plots can be generated as well.

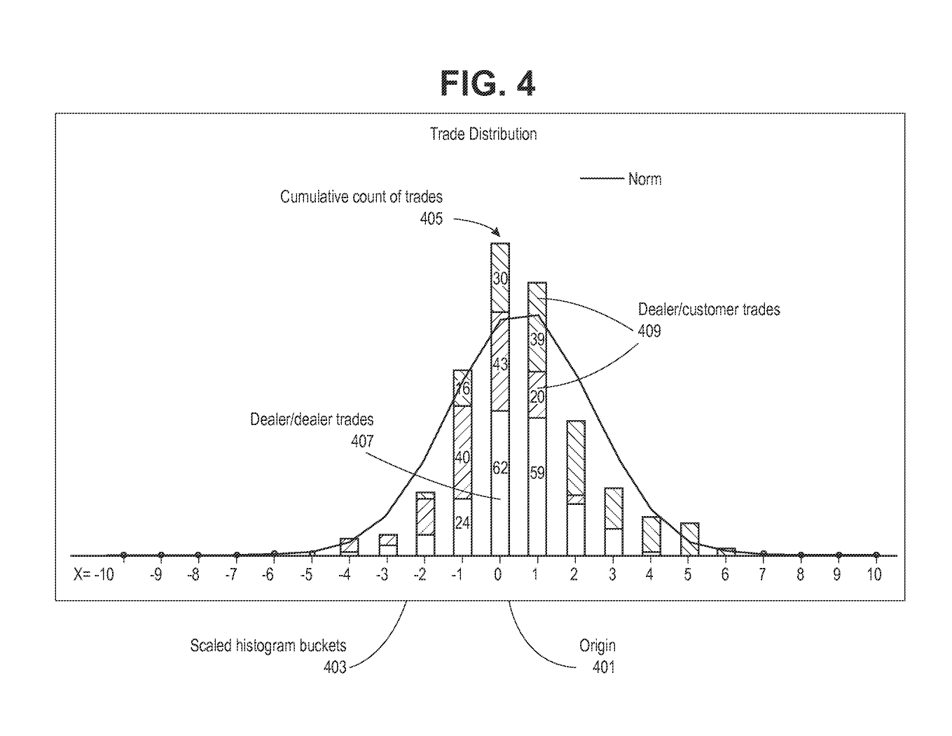

As an example, the data processing apparatus can group transaction data points into different buckets based on the transaction quality parameter associated with each transaction of a low liquidity security. The results the can be output to a display in the form of a plot depicting the variation in spread between reference price and transaction price. FIG. 4 is a plot that classifies each transaction for a given security into a different histogram bucket 403 based on a scaled distance between an actual transaction value and a corresponding reference value (e.g., reference price or reference yield). As shown in FIG. 4, the origin 401 represents a reference value for the security contemporaneous with each relevant transaction. The distance above or below the origin 401 along the horizontal axis represents the spread (in scaled units) between the actual transaction value and the reference value. In the present example, the units of the horizontal axis are expressed as half the bid/ask spread. For example, each transaction in the bucket at x=1 had a scaled value that was approximately 1 above the reference value, whereas each transaction in the bucket at x=−1 had a scaled value that was approximately 1 below the reference value. The vertical axis represents the total volume of trades occurring at the corresponding spread along the horizontal axis. For example, at the origin 401, the cumulative number of trades 405 for a given security that occurred at the reference value corresponds to the sum of trades of the security between dealers (i.e., dealer-dealer trades 407) and trades of the security between dealers and customers (i.e., dealer-customer trades 409). In the present example, dealer-dealer transactions 407 are represented by the light shaded regions at the bottom of each bucket. The dealer-customer trades 409 are represented by the two separate darker shaded regions above the dealer-dealer trades 407. The top portion of each bucket thus corresponds to transactions between a buyer and a dealer, whereas the middle portion of each bucket corresponds to transactions between a seller and a dealer. At the origin, there are 30 transactions for a particular security between a buyer and a dealer, 43 transactions for the particular security between a seller and the dealer, and 62 transactions between dealers. In contrast, as can be seen at x=3 along the horizontal axis, there are 0 transactions between a seller and a dealer. The line “norm” represents a fit to the number of transactions. In an alternative implementation, the sum of the volume of trades can be plotted along the vertical axis instead of the cumulative count of the transactions. The data processing apparatus system receives the data underlying the display. In the exemplary embodiment, this display is limited to a single asset, but alternative embodiments may group multiple assets prior to displaying.

Other operations are also possible. For example, the histogram buckets can be further scaled based on other criteria, such as, for example, by unit of cost for transaction. Alternatively, or in addition, a statistical distribution associated with the histogram can be displayed and, in some implementations overlaid on the histogram itself. In some implementations, each bucket can be modified so as to represent the different sizes of trades associated with the different values (e.g., half the bid/ask spread) along the horizontal axis, as opposed to showing the different types of trades.

The operations described in this specification can be implemented as operations performed by a data processing apparatus on data stored on one or more computer-readable storage devices or received from other sources. For example, FIG. 5 is a schematic representation of an exemplary system 500 in which the illustrated system 500 includes a data processing apparatus, such as programmable processing system 510. The programmable processing system 510 is coupled via the Internet 540 to a user terminal 580, to a plurality of data sources 550A, 550B . . . 550N and to a reporting destination 590. As indicated by dashed line 582, one or more of the data sources 550A, 550B . . . 550N may be connected directly to the processing system 510.

In a typical implementation, the programmable processing system (system) 510 is operable to perform, optionally, in conjunction with one or more of the other illustrated components, methods according to various aspects of the subject matter described in this specification. The system 510 includes a processor 520, a random access memory (RAM) 521, a program memory 522 (for example, a writable read-only memory (ROM) such as a flash ROM), a hard drive controller 523, and an input/output (I/O) controller 524 coupled by a processor (CPU) bus 525. The system 510 can be preprogrammed, in ROM, for example, or it can be programmed (and reprogrammed) by loading a program from another source (for example, from a floppy disk, a CD-ROM, or another computer).

The hard drive controller 523 is coupled to a hard disk 530 suitable for storing executable computer programs, including programs embodying aspects of the subject matter described in this specification, and data discussed in the specification.

The I/O controller 524 is coupled by means of an I/O bus 526 to an I/O interface 527. The I/O interface 527 receives and transmits data (e.g., financial data and reporting data) in analog or digital form over communication links such as a serial link, local area network, wireless link, and parallel link. In some implementations, the I/O interface 527 is connected to a display 528 and a keyboard 529 of a user terminal 580.

In one aspect, the I/O interface 527 is operable as a market data interface for receiving data (e.g., financial data) and representing a series of financial market observations over a period of time. In another aspect, the I/O interface 527 is operable as a transaction data interface for receiving data (e.g., financial data) and representing a series of financial market observations over a period of time. In a typical implementation, the data can be obtained by one or more sources (e.g., 550A, 550B . . . 550N in FIG. 5). The data sources can include, for example, a computer terminal where data is entered manually. Other examples of data sources are provided, for example, in provisional patent application Ser. No. 61/495,793, filed Jun. 10, 2011 and entitled “Fixed Income Securities Market Data Display,” a copy of which is attached hereto.

The I/O interface 527 also provides an access point for a user at user terminal 580 to interact with an access the data and functionality disclosed herein.

The I/O interface 527 in the illustrated implementation, also serves as an interface to a reporting destination 590. Thus, in a typical implementation, any required reporting can be accomplished directly from the user terminal, for example, by accessing the processing system 510.

The processor 520 may be adapted to calculate (or receive) and store a reference value of an asset based on the series of financial market observations and for identifying a set of transaction data points associated with an asset. This information, among other information, can be stored in an electronic database, for example, in RAM module 521.

The processor 520 can also be configured to identify the subset of the market data that comprises the transaction data as well as the transaction data points relevant to a selected asset. The processor 520 can then be used to calculate various metrics based on the data points and relationships identified. This information, too, can be stored in an electronic database, for example, in RAM module 321.

The display 528 (and keyboard 529) forms an exemplary user interface. The display portion of the user interface is generally configured to present information to the user that would be helpful to the user. This can include, for example, an index of securities in various forms, a comparison of multiple securities in the context of liquidity metrics, or a display of liquidity data as shown in FIG. 4.

The display 528 and keyboard 529 can, in a typical implementation, present a list of the financial market observations in the subset. The list can be based on information stored in the electronic database and can include, for example, one or more of the following: a time of the observation, a description of an instrument that the financial market observation relates to, and a type of observation. For trades, the list can further include one or more of trade size, price and yield.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. A computer storage medium can be, or be included in, a computer-readable storage device, a computer-readable storage substrate, a random or serial access memory array or device, or a combination of one or more of them. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be indicated in the numbered paragraphs near the end of this disclosure, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described in the numbered paragraphs near the end of this disclosure as such, one or more features from such a combination can in some cases be excised from the combination, and the combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following numbered paragraphs. For example, though the subject matter of the present disclosure relates to fixed income and OTC derivative markets, the techniques disclosed herein may also be applied to other types of markets, as appropriate. In some cases, the actions recited in the numbered paragraphs can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-based method comprising:
receiving transaction data comprising data relating to one or more transactions of a first security;
obtaining, using a data processing apparatus, one or more reference values, wherein each reference value is contemporaneous with a corresponding transaction of the first security;
generating, using the data processing apparatus, a transaction liquidity factor for each reference value-transaction pair;
combining the transaction liquidity factors into an asset liquidity factor for the first security.

2. The computer-based method of claim 1 wherein the transaction data comprises transaction data selected from the group consisting of transaction data relating to trades in fixed income assets reported by members of FINRA under TRACE and information provided to a centralized recordkeeping facility.

3. The computer-based method of claim 1 wherein the transaction data comprises data related to a single security.

4. The computer-based method of claim 1, further comprising receiving market data, wherein each reference value is based at least in part on the market data, the market data comprising data selected from the group consisting of: data related to interest rate swaps, data related to volatility of options to swap, data related to trades in fixed income assets, data related to information obtained from a swap data repository, data related to treasury prices, data related to credit default swaps, and combinations thereof.

5. The computer-based method of claim 4, further comprising filtering the market data to obtain the transaction data.

6. The computer-based method of claim 1 wherein generating the transaction liquidity factor comprises calculating the transaction liquidity factor according to the formula:
v(t−p)²,
wherein v is volume of a transaction involving the first security, t is the trade value for the transaction involving the first security, and p is the reference value for the transaction involving the first security.

7. The computer-based method of claim 1 wherein combining the transaction liquidity factors comprises calculating a raw liquidity factor according to the formula:
$$\frac{\sum {{v}_{i} ( {t}_{i} - {p}_{i} )}^{2}}{\sum {v}_{i}} , for i = 1 … n ;$$
wherein n is the total number of transactions involving the security, vᵢ is volume of the ith transaction involving the first security, tᵢ is the trade value of the ith transaction involving the first security, and pᵢ is the reference value for the ith transaction involving the first security.

8. The computer-based method of claim 1, further comprising outputting, to a display, a graphical relationship between a portion of the transaction data and the one or more reference values.

9. The computer-based method of claim 8 wherein the graphical relationship comprises a histogram plot, the histogram plot comprising a representation of transaction data and dispersion values.

10. The computer-based method of claim 9 wherein the dispersion values comprise measures of dispersion between transaction values and contemporaneous reference values.

11. The computer-based method of claim 1, further comprising:
selecting one or more additional securities;
obtaining an asset liquidity factor for each additional security in the index; and
generating a liquidity index based on a combination of the asset liquidity factor for each additional security and the asset liquidity factor of the first security.

12. The computer-based method of claim 11 wherein selecting the one or more additional securities is based on one or more asset selection criteria.

13. The computer-based method of claim 12 wherein the asset selection criteria includes one or more criteria selected from the group consisting of in house validation, information related to security issuance, security rating, security time to maturity, security type, and outstanding part amount.

14. The computer-based method of claim 11 wherein the combination comprises a weighted averaging of the asset liquidity factor for each additional security and the asset liquidity factor of the first security.

15. A system comprising:
a transaction data interface for receiving records of transactions related to one or more securities;
a data processing apparatus coupled to the transaction data interface, the data processing apparatus being operable to perform operations comprising:
obtaining one or more reference values, wherein at least one reference values is contemporaneous with a corresponding transaction received by the transaction data interface;
generating an asset liquidity factor for each security; and
outputting to a display information related to the asset liquidity factor for each security.

16. The system of claim 15 wherein generating the asset liquidity factor comprises calculating a dispersion between each reference value and a corresponding transaction value of each security.

17. The system of claim 15 wherein the reference value represents a price of the security or a yield of the security that is contemporaneous with the transaction value.

18. The system of claim 15 wherein the records of transactions comprise data relating to one or more parties participating in at least one of the transactions.

19. The system of claim 18 wherein the records of transactions comprises data relating to one or more selected from the group consisting of: a quantity of transactions, a quantity of securities, and an exchange value.

20. A system comprising:
a market data interface for receiving market data relating to the transactions of a plurality of securities; and
a data processing apparatus coupled to the market data interface, the data processing apparatus being operable to perform operations comprising:
filtering the market data to obtain transaction data related to transactions of one or more specified securities;
obtaining one or more reference values, wherein at least one of the reference values is contemporaneous with a corresponding transaction of the transaction data; and
outputting, to a display, a graphical relationship between a portion of the transaction data and the one or more reference values.

21. The system of claim 20 wherein the graphical relationship comprises a histogram plot, the histogram plot comprising a representation of transaction data and dispersion values.

22. The system of claim 21 wherein the dispersion values comprise measures of dispersion between transaction values and contemporaneous reference values.

23. The system of claim 22 wherein an origin of the histogram plot represents a reference value contemporaneous with a transaction value of a corresponding transaction.

24. The system of claim 22 wherein each contemporaneous reference value corresponds to a reference price or a reference yield.

25. The system of claim 20 wherein the transaction data comprises data relating to information about one or more parties participating in a transaction.

26. The system of claim 25 wherein the graphical relationship comprises a histogram plot, and at least one visual feature of at least a portion of the plot relates to the information about the one or more parties participating in the transaction.

27. The system of claim 21 wherein the transaction data comprises at least one data point selected from the group consisting of: quantity of transactions, quantity of securities transacted, amount of value exchanged, and combinations thereof.

28. The system of claim 21 wherein the histogram plot comprises a display of a plurality of transaction buckets, each bucket representing a range of transaction values in relation to a corresponding contemporaneous reference value.

29. The system of claim 28 wherein the range of transaction values is in units of one half of a spread between a reference bid price and a reference ask price.
